(19) United States
(12) Patent Application Publication
(10) Pub. No.: US 2006/0150632 A1
(43) Pub. Date: Jul. 13, 2006

(54) Gas turbine engine

(76) Inventor: Mark Adrian Bourne, Stafford (GB)

Correspondence Address: SMITH-HILL AND BEDELL, P.C., 16100 NW CORNELL ROAD, SUITE 220, BEAVERTON, OR, 97006, US

(21) Appl. No.: 11/152,594

(22) Filed: Jun. 13, 2005

(30) Foreign Application Priority Data
Jun. 14, 2004 (GB) 0413202.3

(51) Int. Cl. F02C 7/105

(52) U.S. Cl. 60/772; 60/39.512

(57) ABSTRACT

A gas turbine engine includes a heat exchanger for heating an airflow. The engine is arranged so that in use the heat exchanger is heated and in turn heats the airflow.

### CROSS-REFERENCE TO RELATED APPLICATION

This application claims priority under 35 USC 119 of United Kingdom Patent Application No. 0413202.3 filed Jun. 14, 2004.

### BACKGROUND OF THE INVENTION

The present invention relates to gas turbine engines.

Gas turbine engines are widely used, particularly in aviation and power generation, and the principle of operation of gas turbine engines is well known. Typically, gas turbine engines operate at high temperatures, pressures and rotational speeds and are therefore relatively expensive to both manufacture and operate. This has meant that the provision of small scale, working gas turbine engines for demonstration and teaching purposes in educational establishments has been beyond the financial resources of most general education establishments such as schools. However, the gas turbine engine provides an exciting and inspiring example of the application of many scientific and engineering principles.

### SUMMARY OF THE INVENTION

According to the present invention, there is provided a gas turbine engine, the engine including a heat exchanger for heating an airflow, the engine being arranged so that in use the heat exchanger is heated and in turn heats the airflow.

Preferably the engine is arrangeable in a first operating condition in which the heat exchanger is heated, and a second operating condition in which the heat exchanger is not substantially heated.

Also according to the present invention, there is provided a method of operating a gas turbine engine, the engine including a heat exchanger for heating an airflow, the method including arranging the engine in a first operating condition in which the heat exchanger is heated, and then a second operating condition in which the heat exchanger is not substantially heated.

Preferably, in the first operating condition, there is substantially no airflow through the engine. Preferably, in the second operating condition the heat exchanger heats the airflow.

Preferably, the heat exchanger is arranged to substantially store heat in the first operating condition for release in the second operating condition to heat the airflow.

Preferably, in the first operating condition the temperature of the heat exchanger is raised. Preferably, in the second operating condition the temperature of the heat exchanger falls.

Preferably the engine includes a compressor for compressing the airflow. Preferably, the compressor includes an impeller. Preferably the engine includes a turbine which is driven by the airflow. Preferably the turbine includes a turbine blade assembly. Preferably, the impeller is coupled to the turbine blade assembly, and in use may be driven by the turbine blade assembly. Preferably, the impeller and the turbine blade assembly each rotate about an axis, which may be the same axis.

Preferably, the impeller and/or the turbine blade assembly are formed of aluminium.

Preferably the compressor and the turbine are each mounted on a shaft, which is preferably the same shaft, and may be located substantially adjacent to each other. The engine may include a substantially planar support plate having two opposed faces, and the compressor and the turbine may be mounted one on each opposed face. Preferably, the compressor is a centrifugal compressor, in which the airflow enters inwardly axially and is expelled radially. Preferably, the turbine is arranged so that the airflow enters the turbine axially and exits radially. Preferably, the engine is arranged so that the direction in which the airflow enters the compressor is opposite to the direction in which the airflow enters the turbine.

Preferably, the heat exchanger defines a passage along which the airflow passes, and may define a plurality of airflow passages.

Preferably, the heat exchanger includes a tube or tubes which define the passage or passages.

Alternatively, the heat exchanger includes a block of material which defines the passage or passages.

Preferably, the heat exchanger is thermally insulated.

Preferably the heat exchanger is formed of a material having a relatively high specific heat capacity, and may be formed of a metal such as steel or aluminium.

Preferably the engine includes a heat source for generating heat. Preferably the heat source heats the heat exchanger. The heat source may be electrically powered, or may be gas fired.

In one embodiment, the heat source may heat a fluid which in turn heats the heat exchanger. The fluid may be air or any other suitable fluid.

In another embodiment, the heat source includes an electrical heating element which is located on a surface of or embedded within the heat exchanger.

In a further embodiment, the heat source includes a gas fired burner which applies heat to a surface of the heat exchanger.

Further according to the present invention, there is provided a gas turbine engine, the engine including a compressor and turbine assembly, the assembly including a compressor and a turbine, the compressor and turbine being mounted on a shaft and located adjacent to each other on the shaft.

Preferably, other features of the engine are as set out above.

Still further according to the present invention, there is provided a compressor and turbine assembly for a gas turbine engine, the assembly including a compressor and turbine as set out above.

Yet further according to the present invention, there is provided a heat exchanger for a gas turbine engine, the heat exchanger being as set out above.

### BRIEF DESCRIPTION OF THE DRAWGINS

Embodiments of the present invention will now be described by way of example only, and with reference to the accompanying drawings, in which:

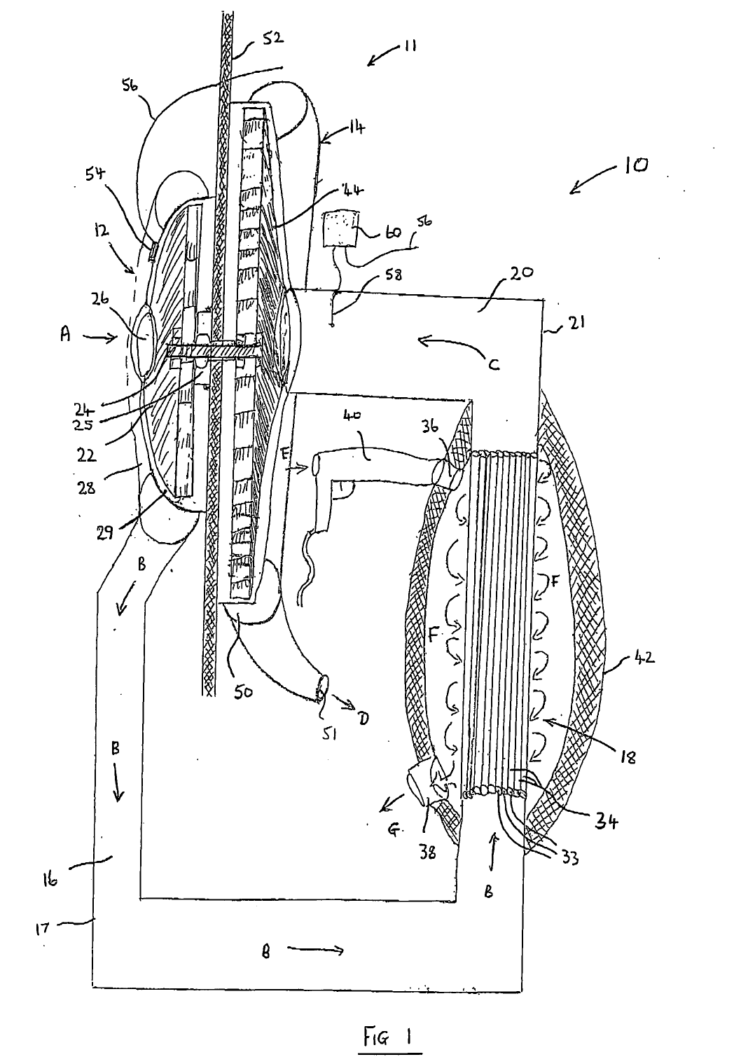

FIG. 1 is a diagrammatic sectional view of a gas turbine engine according to the invention;

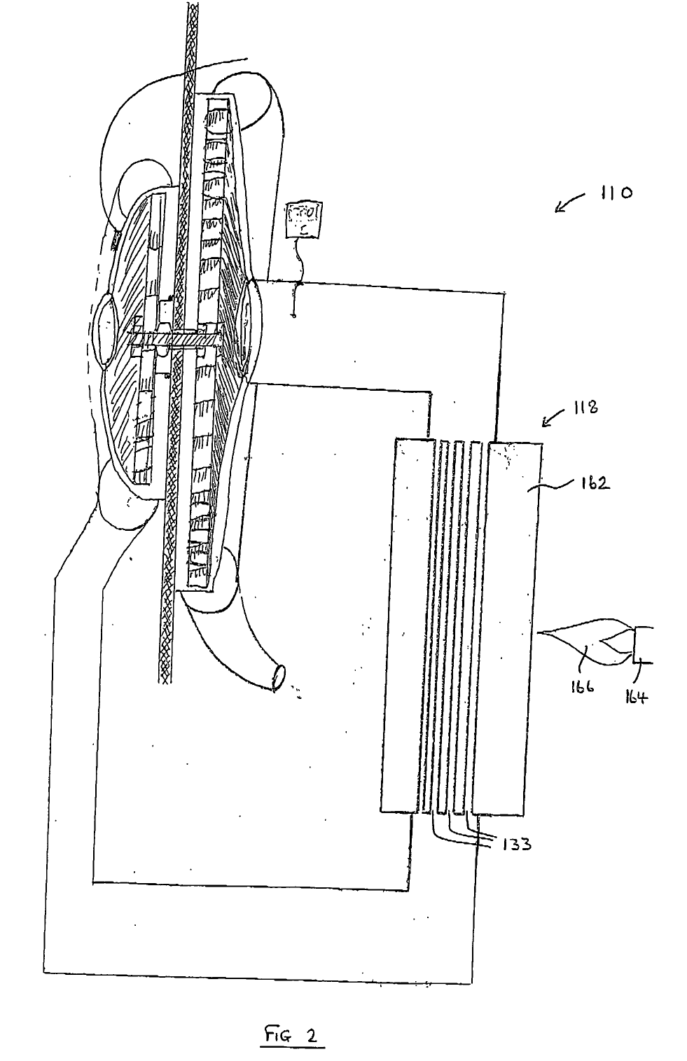

FIG. 2 is a diagrammatic sectional view of another engine according to the invention; and

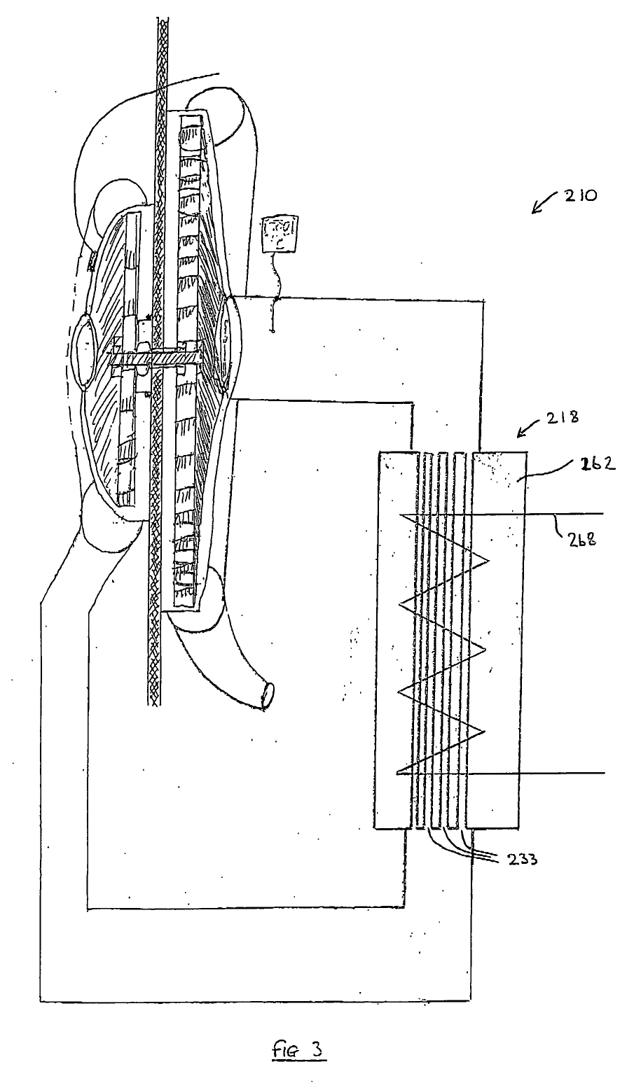

FIG. 3 is a diagrammatic sectional view of a further engine according to the invention.

### DETAILED DESCRIPTION

Referring to FIG. 1, FIG. 1 shows a gas turbine engine 10 according to the invention, the engine 10 including a centrifugal compressor 12, a heat exchanger 18 and a turbine 14. Ductwork 17 defining a duct 16 extends between the compressor 12 and the heat exchanger 18, and ductwork 21 defining a duct 20 extends between the heat exchanger 18 and the turbine 14.

The compressor 12 comprises an impeller 22 mounted on a shaft 24, the shaft 24 being mounted in a bearing 25 to one face of a substantially planar insulated support plate 52. The compressor 12 includes a casing 28 extending around the impeller 22 and defining a compressor interior 29, the interior 29 in communication with the duct 16. The casing 28 defines an air inlet aperture 26.

The heat exchanger 18 includes a plurality of parallel tubes 34, each tube 34 defining a passage 33. The heat exchanger 18 is located within a cavity 43 defined by a layer of insulation 42. The insulation 42 defines an inlet aperture 36 and an outlet aperture 38. A heat source in the form of an electrically powered hot air gun 40 is positioned at the inlet aperture 36.

The turbine 14 includes a turbine blade assembly 44 which is mounted to an opposite face 72 of the support plate 52 and an end of the shaft 24 extending through the support plate 52. A turbine casing 50 extends around the turbine blade assembly 44 and defines an outlet aperture 51.

The turbine 14 and compressor 12 form an assembly 11, being mounted “back to back” on opposite faces of the support plate 52 substantially adjacent each other so that the length of the shaft 24 is minimised and only one bearing 25 is required.

A tachometer 54 is located within the casing 28 of the compressor 12, a lead 56 extending from the tachometer 54 to a computer or data logger (not shown). The tachometer comprises a photodiode and a phototransistor which sense the rotation of the impeller 22. A K type thermocouple temperature sensor 58 is positioned within the duct 20, in communication with a display 60 and via a lead 56 to a computer or data logger (not shown).

In use, the engine is operated in two operating conditions. In a first operating condition the impeller 22 and the turbine blade assembly 44 are stationary, and there is substantially no air flow through the passages 33. The hot air gun 40 is operated, drawing in air as indicated by arrow E, heating the air and supplying the heated air through the inlet aperture 36 to the cavity 43 and the heat exchanger 18. The heated air circulates around the tubes 34 as indicated by arrows F, heating up the tubes 34 so that the temperature of the heat exchanger 18 rises, before being exhausted from the insulated cavity 43 through the outlet aperture 38 as indicated by arrow G. Operation of the hot air gun 40 continues until the heat exchanger 18 has reached a suitable temperature. In one example, the suitable temperature could be approximately 400° C.

When the heat exchanger 18 has reached the suitable temperature, the engine is operated in the second operating condition, in which the operation of the hot air gun 40 ceases so that substantially no further heat is applied to the heat exchanger 18. The shaft 24 is initially rotated by a means such as an electric motor (not shown), or by directing a flow of air into the compressor inlet aperture 26. As the shaft 24 rotates, the impeller 22 rotates, drawing a flow of air inwardly axially through the air inlet aperture 26 as indicated by arrow A and compressing the air flow. The air flow is collected by the casing 28 and is expelled radially, being directed along the duct 16 as indicated by arrows B to the passages 33 of the heat exchanger 18. The air flow passes along the passages 33 and is heated by the heat exchanger 18. The heated air flow is then directed along the duct 20 as indicated by arrow C to the turbine blade assembly 44, entering the turbine blade assembly axially but in a direction opposite to the direction in which the airflow enters the compressor 12. The heated air drives the turbine blade assembly 44, in turn rotating the shaft 24 and the impeller 22, drawing in fresh air at the air inlet 26. After driving the turbine blade assembly 44, the heated air flow passes into the turbine casing 50, exiting radially through the outlet aperture 51 as indicated by arrow D.

After initially starting rotation of the shaft 24, the assistance of the electric motor or the air flow in causing rotation of the shaft 24 is no longer required, as the turbine blade assembly 44 is driven by the heated air flow. The engine 10 will continue to operate with fresh air being drawn into the compressor air inlet 26 and hot air exhausted from the air outlet 51 as long as sufficient heat energy is transferred from the heat exchanger 18 to the air flow to cause rotation of the turbine blade assembly 44. As operation continues, the heat exchanger 18 will cool down, the temperature of the heat exchanger 18 falling, during which time the shaft 24 will rotate progressively more slowly until the shaft 24, the turbine blade assembly 44 and the compressor impeller 22 come to rest.

The temperature to which the heat exchanger 18 must be raised, and the temperature of the heat exchanger 18 at which rotation of the shaft 24 stops will depend upon the construction of the engine. The higher the temperature to which the heat exchanger 18 is heated, the longer the engine 10 will continue to run. Longer running times can be achieved by using lighter materials of construction such as aluminium for the impeller 22 and the turbine blade assembly 44. The relatively short shaft 24 and single bearing 25 reduce rotational inertia and friction, maximising the running time of the engine.

During operation, the tachometer 54 and the temperature sensor 58 permit monitoring of the speed of rotation of the shaft 24 and the temperature of the air flow in the duct 20 respectively. The speed and temperature values sensed can be recorded on the computer or datalogger for analysis.

An example of the engine of a size suitable for location on a table top, using simple vacuum cleaner or automotive parts for the compressor and turbine and with the heat exchanger heated to a temperature of 400° C., could run for approximately one minute and output 15-20 Kw, with a noise level similar to that of a domestic vacuum cleaner.

FIG. 2 shows another gas turbine engine 110 according to the invention. The engine 110 shown in FIG. 2 is similar to the engine shown in FIG. 1 and described above, except that the heat exchanger 118 is in the form of a metal block 162 which defines a plurality of passages 133. A flame 166 produced by a gas burner 164 is used to heat the surface of the block 162. Operation of the engine 110 is otherwise exactly the same as that described previously.

FIG. 3 shows a further example of an engine according to the invention. Engine 210 is similar to that described above and shown in FIG. 2. The engine 210 includes a heat exchanger 218 comprising a metal block 262. An electrical element 268 is embedded within the block 262 to heat the block 262 in the first operating condition. Otherwise operation of the engine is the same as that described previously. Alternatively, the electrical element 268 could be located on a surface of the block 262.

Various other modifications may be made without departing from the scope of the invention. The compressor 12, the turbine 14 and the heat exchanger could be arranged differently. Means could be provided to positively prevent air flow in the first operating condition such as the provision of a valve in ducts 16 or 20. Alternatively or additionally, means could be provided to prevent rotation of the shaft 24 in the first operating condition such as a shaft brake or clutch. The hot air exiting from the turbine casing outlet aperture 51 could be recycled to the hot air gun or heat exchanger, which could assist in extending the running time of the engine in the second operating condition. Further instrumentation could be provided, such as air flow, temperature and pressure sensors. The engine could be mounted on a trolley or chassis and the turbine outlet aperture 51 could be arranged to provide thrust. A strain gauge could be provided on the trolley or chassis to measure the thrust developed by the engine.

The compressor casing could be transparent to permit viewing of the impeller in operation. The heat exchanger could be formed of any suitable material having a relatively high specific heat capacity, such as steel or aluminium.

The invention thus provides an engine which is particularly suited for use in educational establishments to demonstrate the principles of operation of a gas turbine engine. The engine is of relatively simple construction, and operates at relatively low temperatures and pressures in comparison with a conventional gas turbine engine, so that common and relatively inexpensive materials can be used. For instance, the turbine blade assembly could be formed of aluminium. Readily available turbine blade assemblies could be used, such as those used in vacuum cleaners or vehicle engines. The bearing could be an inexpensive ball race bearing.

The operation of the engine in two operating conditions permits control of the maximum temperature obtained by the engine so that the engine can be safely started and run in the second operating condition, since in a second operating condition no heat is supplied by the heat source into the engine, allowing use of the engine in laboratories and classrooms. In particular, the feature that no heat is supplied into the engine in the second operating condition demonstrates the principle that the gas turbine engine is driven by heating of the working fluid, namely air, rather than the vaporisation and burning of fuel, which is a common misconception. With appropriate instrumentation, many principles of physics and thermo-dynamics can be demonstrated in an exciting and inspiring way.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A gas turbine engine, the engine including a heat exchanger for heating an airflow, the engine being arranged so that in use the heat exchanger is heated and in turn heats the airflow.

2. An engine according to claim 1, wherein the engine includes a compressor for compressing the airflow and a turbine which is driven by the airflow, the compressor and the turbine each being mounted substantially adjacent to each other on a shaft.

3. An engine according to claim 2, wherein the engine includes a substantially planar support plate having two opposed faces, and the compressor and the turbine are mounted one on each opposed face.

4. An engine according to claim 2, wherein the engine is arranged so that the direction in which the airflow enters the compressor is opposite to the direction in which the airflow enters the turbine.

5. An engine according to claim 2, wherein the compressor includes an impeller and the turbine includes a turbine blade assembly,
the impeller being coupled to the turbine blade assembly, and in use being driven by the turbine blade assembly.

6. An engine according to claim 2, wherein the compressor is a centrifugal compressor, in which the airflow enters inwardly axially and is expelled radially.

7. An engine according to claim 2, wherein the turbine is arranged so that the airflow enters the turbine axially and exits radially.

8. An engine according to claim 1, wherein the heat exchanger defines a passage or passages along which the airflow passes.

9. An engine according to claim 1, wherein the heat exchanger is thermally insulated

10. An engine according to claim 1, wherein the heat exchanger is formed from a material having a relatively high specific heat capacity such a steel or aluminium.

11. An engine according to claim 1, wherein the engine includes a heat source for generating heat which heats the heat exchanger.

12. An engine according to claim 11, wherein the heat source heats a fluid which in turn heats the heat exchanger.

13. An engine according to claim 11, wherein the heat source is electrically powered

14. An engine according to claim 11, wherein the heat source is gas fired.

15. A gas turbine engine, the engine including a compressor and turbine assembly, the assembly including a compressor and a turbine, the compressor and turbine being mounted on a shaft and located adjacent to each other on the shaft.

16. A method of operating a gas turbine engine, the engine including a heat exchanger for heating an airflow, the method including arranging the engine in a first operating condition in which the heat exchanger is heated, and then a second operating condition in which the heat exchanger is not substantially heated.

17. A method according to claim 16, wherein in the first operating condition, there is substantially no airflow through the engine and in the second operating condition the heat exchanger heats the airflow.

18. A method according to claim 16, wherein the heat exchanger is arranged to substantially store heat in the first operating condition for release in the second operating condition to heat the airflow.

19. A method according to claim 16, wherein in the first operating condition the temperature of the heat exchanger is raised and in the second operating condition the temperature of the heat exchanger falls.
